(19) United States
(12) Patent Application Publication
(10) Pub. No.: US 2015/0363802 A1
(43) Pub. Date: Dec. 17, 2015

(54) SURVEY AMPLIFICATION USING RESPONDENT CHARACTERISTICS

(71) Applicant: Google Inc., Mountain View, CA (US)

(72) Inventors: Hal Ronald Varian, Mountain View, CA (US); Seth Stephens-Davidowitz, Mountain View, CA (US); Jeffrey David Oldham, San Jose, CA (US)

(73) Assignee: Google Inc., Mountain View, CA (US)

(21) Appl. No.: 14/085,086

(22) Filed: Nov. 20, 2013

(51) Int. Cl. G06Q 30/02

(52) U.S. Cl. CPC G06Q 30/0203

(57) ABSTRACT

Survey accuracy of small sample sizes may be amplified by including, excluding, or weighting survey responses of respondents responsive to characteristics of the respondent being correlated with or not correlated with characteristics of the population determined from aggregated behavioral histories of the population, resulting in favoring survey results of individuals that are truly representative of the larger population and excluding results from outliers. Search queries from devices in a particular region may be aggregated to identify common searches, building a model of characteristics of the regional population without requiring any private or confidential data of the population. Surveys may be given to a small number of individuals in the region, and if the individual's characteristics match the modeled regional characteristics, then the individual's survey responses may be used to build a statistical estimate of responses from the region, at a higher degree of confidence than allowed by mere random sampling.

### BACKGROUND

Surveys may be used for various purposes, including marketing, education, political analysis, or others. While a 100% response rate for a survey presented to every member of a population would theoretically give perfectly accurate results for the survey question, such a high response rate is rare, if not impossible to achieve. Typical response rates may be on the order of 10-30% or lower, reducing accuracy or confidence in the applicability of the results to the larger population. Furthermore, surveys are not typically presented to every member of a population due to expense, and so the results from a very small number of survey respondents may be used, with low confidence, in an attempt to predict the behavior of a large group of individuals. For example, national political polls during election years frequently have sample sizes of approximately 1,000 randomly selected registered voters in an attempt to estimate the outcome of over 125 million actual votes. Even doubling the sample size (and accordingly, the survey cost) may only result in a negligible increase in accuracy.

### SUMMARY

Surveyed individuals need not be selected randomly, or survey results may be included or excluded responsive to characteristics of the individual being correlated with or not correlated with characteristics of the population. Accordingly, accuracy may be increased by including survey results of individuals that are truly representative of the larger population and excluding results from outliers. The characteristics of individuals may include demographic information, behavioral traits, or affinities, and may be determined explicitly through surveys or user profiles, or implicitly through Internet browser histories, search histories, or a combination of these or such data. The characteristics of the population may be similarly determined explicitly through larger population surveys, census data, or birth records, or implicitly through aggregated search histories of devices within the population, or a combination of these or other such data. For example, search queries from devices located in a particular city may be aggregated to identify common searches, building a model of characteristics of the city population without requiring any private or confidential data of the population. Surveys may be given to individuals who have opted-in or explicitly agreed to participate, and if the individual's characteristics match the city characteristics, then the individual's survey responses may be used to build a statistical estimate of responses from the city population, at a higher degree of confidence than allowed by mere random sampling.

One implementation disclosed herein is a method for improving targeted distribution of content via regional behavioral histories. The method includes receiving, by a device, a plurality of device identifiers, and for each of the plurality of device identifiers, a corresponding survey result and a corresponding behavioral history associated with said device identifier. The method also includes identifying, by the device, a value of at least one affinity associated with a given survey result, based on a correlation of behavioral histories associated with device identifiers corresponding to the given survey result. The method further includes identifying, by the device, a region associated with the plurality of device identifiers; and retrieving, by the device, an aggregated behavioral history for the determined region. The method also includes calculating, by the device, a survey result probability for the determined region, based on the aggregated behavioral history and the identified value of the at least one affinity. The method further includes retrieving, by the device, at least one item of content associated with the survey result, the at least one item of content selected based on the survey result probability; and distributing, by the device, the at least one item of content to a plurality of devices located in the determined region.

In some implementations, the method includes identifying the value of at least one affinity associated with a given survey result by extracting, from the plurality of behavioral histories associated with the plurality of device identifiers, a subset of behavioral histories associated with a device identifier with a corresponding survey result matching the given survey result. In a further implementation, the method includes identifying, from the subset of behavioral histories, a rate of appearance of one or more predetermined keywords corresponding to an affinity. In a still further implementation, the method includes searching each behavioral history of the subset of behavioral histories for the one or more predetermined keywords corresponding to the affinity.

In some implementations, the method includes identifying a region associated with the plurality of device identifiers by receiving, for each of the plurality of device identifiers, a location identifier. In a further implementation, the method includes identifying a geographic region corresponding to the plurality of location identifiers.

In some implementations, the method includes retrieving an aggregated behavioral history for the determined region by retrieving an aggregated list of search queries of a second plurality of devices located in the determined region. In some implementations, the method includes calculating a survey result probability for the determined region by identifying, from the aggregated behavioral history for the determined region, a second value of the affinity within a predetermined range from the identified value of the affinity. In one implementation, the method includes distributing the at least one item of content to the plurality of devices located in the determined region by distributing the at least one item of content via a broadcast medium. In another implementation, the method includes distributing the at least one item of content to the plurality of devices located in the determined region by distributing the at least one item of content agnostic to device identifiers of the plurality of devices.

Another implementation presented in the present disclosure is a system for improving targeted distribution of content via regional behavioral histories. The system includes a device, comprising a processor and a memory. The processor is configured for receiving a plurality of device identifiers, and for each of the plurality of device identifiers, a corresponding survey result and a corresponding behavioral history associated with said device identifier. The processor is also configured for identifying a value of at least one affinity associated with a given survey result, based on a correlation of behavioral histories associated with device identifiers corresponding to the given survey result. The processor is further configured for identifying a region associated with the plurality of device identifiers, and retrieving an aggregated behavioral history for the determined region. The processor is also configured for calculating a survey result probability for the determined region, based on the aggregated behavioral history and the identified value of the at least one affinity. The processor is further configured for retrieving at least one item of content associated with the survey result, the at least one item of content selected based on the survey result probability, and distributing the at least one item of content to a plurality of devices located in the determined region.

In some implementations, the processor is further configured for extracting, from the plurality of behavioral histories associated with the plurality of device identifiers, a subset of behavioral histories associated with a device identifier with a corresponding survey result matching the given survey result. In a further implementation, the processor is further configured for identifying, from the subset of behavioral histories, a rate of appearance of one or more predetermined keywords corresponding to an affinity. In a still further implementation, the processor is further configured for searching each behavioral history of the subset of behavioral histories for the one or more predetermined keywords corresponding to the affinity.

In some implementations, the processor is further configured for receiving, for each of the plurality of device identifiers, a location identifier. In a further implementation, the processor is further configured for identifying a geographic region corresponding to the plurality of location identifiers.

In some implementations, the processor is further configured for retrieving an aggregated list of search queries of a second plurality of devices located in the determined region. In some implementations, the processor is further configured for identifying, from the aggregated behavioral history for the determined region, a second value of the affinity within a predetermined range from the identified value of the affinity. In one implementation, the processor is further configured for distributing the at least one item of content via a broadcast medium. In another implementation, the processor is further configured for distributing the at least one item of content agnostic to device identifiers of the plurality of devices.

Still another implementation presented in the present disclosure is a computer-readable storage medium storing instructions that when executed by one or more data processors, cause the one or more data processors to perform operations including receiving a plurality of device identifiers, and for each of the plurality of device identifiers, a corresponding survey result and a corresponding behavioral history associated with said device identifier, and identifying a value of at least one affinity associated with a given survey result, based on a correlation of behavioral histories associated with device identifiers corresponding to the given survey result. The instructions also cause the one or more data processors to perform operations including identifying a region associated with the plurality of device identifiers, retrieving an aggregated behavioral history for the determined region, and calculating a survey result probability for the determined region, based on the aggregated behavioral history and the identified value of the at least one affinity. The instructions also cause the one or more data processors to perform operations including retrieving at least one item of content associated with the survey result, the at least one item of content selected based on the survey result probability, and distributing the at least one item of content to a plurality of devices located in the determined region.

These implementations are mentioned not to limit or define the scope of the disclosure, but to provide an example of an implementation of the disclosure to aid in understanding thereof. Particular implementations may be developed to realize one or more of the following advantages.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a diagram of a plurality of clients, a portion of which are connected via a network to a server and at least one content provider, according to one implementation;

FIG. 2A is a block diagram of a client device, according to one implementation;

FIG. 2B is a block diagram of a server device, according to one implementation;

FIG. 3 is a flow diagram of the steps taken in one implementation of a process for providing access to content responsive to successful completion of a survey;

FIG. 4 is a flow diagram of the steps taken in one implementation of a process for improving targeted distribution of content via regional search histories; and

FIG. 5 is a flow diagram of the steps taken in one implementation of a process for survey amplification.

Like reference numbers and designations in the various drawings indicate like elements.

### DETAILED DESCRIPTION

According to various aspects of the present disclosure, accuracy of a survey may be increased or amplified by including survey results of individuals that are truly representative of the larger population and excluding results from outliers. Characteristics of survey respondents, such as demographic information, behavioral traits, or affinities, may be compared to similar characteristics of a generated model of individuals in a region to determine whether the respondent is or is not representative of the region. Characteristics of the respondents may be determined explicitly through surveys or user profiles, or implicitly through Internet browser histories, search histories, or a combination of these or such data. The model may be generated based on characteristics of the population, which may be similarly determined explicitly through larger population surveys, census data, or birth records, or implicitly through aggregated search histories of devices within the population, or a combination of these or other such data. Accordingly, by excluding or weighting down results from non-representative respondents, or by including or increasing weights of results from representative respondents, statistical inaccuracies due to small sample size may be reduced and confidence of results increased.

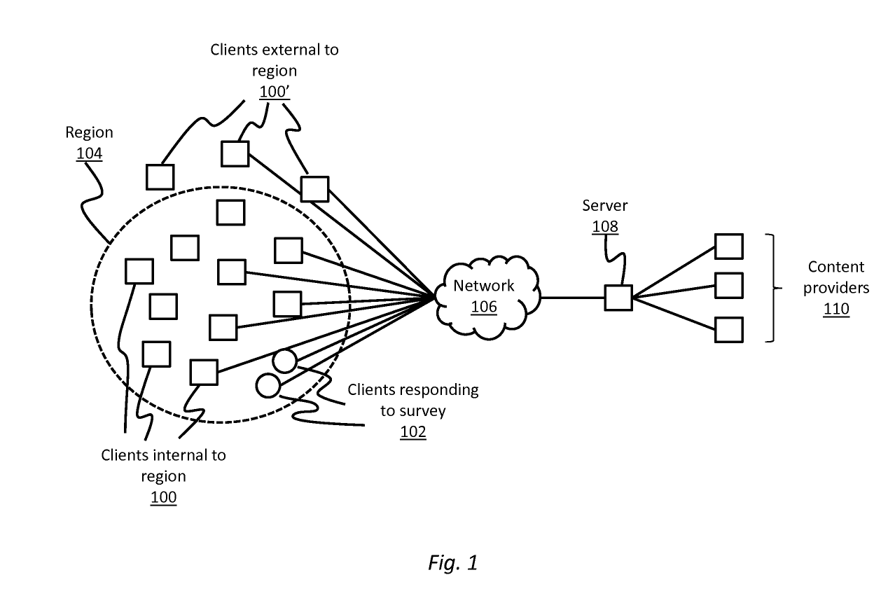

Referring to FIG. 1, a diagram of a plurality of clients 100, 100′, a portion of which are connected via a network 106 to a server 108 and at least one content provider 110, in accordance with a described implementation is shown. Clients 100, 100′ may refer to individuals, referred to variously as users, members of a population, residents, or by other such terms; or may refer to devices of these individuals, including desktop and laptop computers, smart phones, tablets, radios, televisions, or other such devices. When referring to devices, clients 100, 100′ may be connected to one or more networks 106, discussed in more detail below, or may be disconnected and receive content, such as image, video, or audio content, via other means. For example, radios and televisions may receive content via cable, analog or digital terrestrial broadcasts, or satellite broadcasts. Similarly, individuals may receive content via any of the aforementioned devices, or may receive content via postal mail or view content publicly, such as advertising displayed on billboards or other signage. Other clients may not receive content by any such means.

As shown in FIG. 1, a portion of clients 100 may be within a region 104, and a portion of clients 100′ may be outside of the region 104. A region 104 may be a geographical region, such as a city, town, neighborhood, block, street, nation, province, county, or any other size region. Although shown as a circle, a geographical region 104 may have any shape of boundary. In other implementations, a region 104 may define a grouping of similar entities and may be referred to as a virtual region or a set. For example, in one such implementation, clients 100 comprising left handed individuals or devices of left handed individuals may be grouped in a virtual region 104, while clients 100′ comprising right handed individuals may be external to the region 104. In another implementation, a region 104 may be defined by a time or range of time, to allow grouping of responses by response time (e.g. a time at which the response is received from the respondent, a time at which the survey is presented to the client, etc.). Time-based regions also be used to separate or identify survey targets for periodic surveys (e.g. clients who have not received and/or responded to a survey within three months, etc.). In some implementations, these features may be combined such that a region may be defined by a geographical boundary and one or more traits. This may allow targeting of content based on any combination of one or more mutually disjoint characteristics, such as residence within a city or not, likelihood to purchase a particular product within a specified time period, interest in a particular sports team, or any other such characteristics.

One or more clients 102 within the region 104 may be presented with, and respond to, a survey. In one implementation, the client 102 or a device of the client 102 may transmit a response to the survey via network 106 to a server 108. In other implementations, the client 102 may respond to a verbal or in-person survey, a mail survey, a survey presented at a public access point or terminal, such as a kiosk, public-use computer, automatic teller machine, or any other such device. Clients 102 responding to surveys may comprise a very small subset of clients 100 within region 104, such as 10% of the region population, 5%, 1%, 0.1%, 0.01%, or even smaller. For example, a city of one million residents may have as many as ten thousand survey respondents or as few as one or two. By ensuring that respondents' characteristics correspond to aggregated population characteristics, the statistical accuracy of even very small sample sizes may be increased.

In some implementations, clients 102 or users of device clients 102 may be provided with an opportunity to control what demographic information, behavioral characteristics, or other traits are collected for correlation against aggregated region data. In some such implementations, demographic information about or identities of clients 102 or the users of device clients 102 may be anonymized so that any personally identifiable information is removed. For example, collected information may be disambiguated to one or more parameters, such as replacing specific Internet search queries with identifiers of a predetermined category of queries, replacing address information with ZIP code or city information, or replacing a birthdate or age with an age range.

Network 106 may be any form of computer network or combinations of networks that relay information between clients 100, 100′, 102 or devices of such clients, one or more servers 108, and one or more content providers 110. For example, network 106 may include the Internet and/or other types of data networks, such as a local area network (LAN), a wide area network (WAN), a cellular network, satellite network, or other types of data networks. Network 106 may also include any number of computing devices (e.g., computer, servers, routers, network switches, etc.) that are configured to receive and/or transmit data within network 106. Network 106 may further include any number of hardwired and/or wireless connections. For example, a client 102 or device of a client 102 may communicate wirelessly (e.g., via WiFi, cellular, radio, etc.) with a transceiver that is hardwired (e.g., via a fiber optic cable, a CATS cable, etc.) to other computing devices in network 106. In still other implementations, a network 106 may include a virtual or abstract network, such as an offline transfer of data via physically movable media (e.g. a Sneakernet, transferring data via tape media, CD-ROM, flash media, external hard drives, floppy disks, etc.). As discussed above, some clients may be disconnected from a network 106 or may be connected to the network but also receive content via other means, such as terrestrial radio or television broadcasts or billboards. Similarly, many clients may receive content both via network 106 and via other such systems.

Server 108, described in more detail below, may include one or more computing devices connected to network 106 and configured for receiving survey responses from clients 102 and correlating respondent characteristics with region characteristics. Server 108 may be a plurality of devices configured in a server farm or server cloud for distributed processing, and may provide other functions. In one implementation, server 108 may be an intermediary between one or more content providers 110 and clients 100, 100′, 102, while in other implementations, server 108 may communicate with content providers 110 via network 106.

Content providers 110 may include one or more computing devices in communication with server 108 and configured to provide content to clients 100, 100′, 102. For example, content providers 110 may be computer servers (e.g., FTP servers, file sharing servers, web servers, etc.) or combinations of servers (e.g., data centers, cloud computing platforms, etc.). Content providers 110 may provide any type and form of content, including text, images, video, audio, other data, or any combination of these. Content may include movies, television shows, news articles, podcasts, video games or other interactive content, advertising in any format, websites, social media, or any other type and form of content. For example, content provider 110 may be an online search engine that provides search result data to client device 100, 102 in response to a search query. In another example, content provider 110 may be a first-party web server that provides webpage data to client device 100, 102 in response to a request for the webpage.

In some implementations, discussed in more detail below, content may be divided into standard content and premium content, the latter of which requires special privileges to access. For example, a news website may provide an excerpt of a story as standard content to any device accessing the website, but may only provide the full story as premium content to a device with an identified subscription, or which has fulfilled a task to gain access to the premium content, such as responding to a survey. Although shown separately, in some implementations, a server 108 and a content provider 110 may be the same device or farm of devices.

According to various implementations, any of content providers 110 may provide first-party webpage data to client devices 100, 102 that includes one or more content tags. In general, a content tag refers to any piece of webpage code associated with the action of including third-party content with a first-party webpage. For example, a content tag may define a slot on a webpage for third-party content, a slot for out of page third-party content (e.g., an interstitial slot), whether third-party content should be loaded asynchronously or synchronously, whether the loading of third-party content should be disabled on the webpage, whether third-party content that loaded unsuccessfully should be refreshed, the network location of a content source that provides the third-party content (e.g., another content provider 110, server 108, etc.), a network location (e.g., a URL) associated with clicking on the third-party content, how the third-party content is to be rendered on a display, a command that causes client device 100, 102 to set a browser cookie (e.g., via a pixel tag that sets a cookie via an image request), one or more keywords used to retrieve the third-party content, and other functions associated with providing third-party content with a first-party webpage. For example, content provider 110 may serve first-party webpage data to client device 100, 102 that causes client device 100, 102 to retrieve third-party content from server 108. In another implementation, content may be selected by server 108 and provided by content provider 110 as part of the first-party webpage data sent to client device 100, 102. In a further example, content server 108 may cause client device 100, 102 to retrieve third-party content from a specified location.

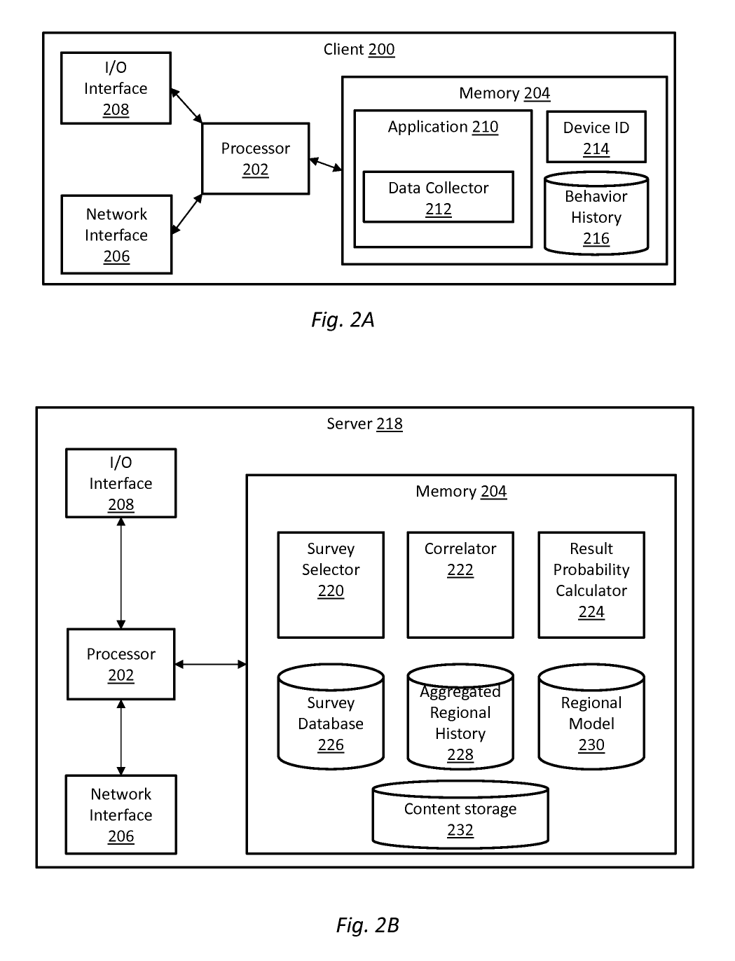

Illustrated in FIG. 2A is a block diagram of one implementation of a computing device 200 of a client such as clients 100, 102. Client device 200 may be any number of different types of user electronic devices configured to communicate via network 106, including without limitation, a laptop computer, a desktop computer, a tablet computer, a smartphone, a digital video recorder, a set-top box for a television, a video game console, or any other type and form of computing device or combinations of devices. In some implementations, the type of client device 200 may be categorized as a mobile device, a desktop device or a device intended to remain stationary or configured to primarily access network 106 via a local area network, or another category of electronic devices such as a media consumption device. In other implementations, as discussed above, devices of clients 100 may include televisions or radios, and thus may lack some of the features illustrated in FIG. 2A.

In many implementations, Client device 200 includes a processor 202 and a memory 204. Memory 204 may store machine instructions that, when executed by processor 202 cause processor 202 to perform one or more of the operations described herein. Processor 202 may include a microprocessor, ASIC, FPGA, etc., or combinations thereof. In many implementations, processor 202 may be a multi-core processor or an array of processors. Memory 202 may include, but is not limited to, electronic, optical, magnetic, or any other storage devices capable of providing processor 202 with program instructions. Memory 202 may include a floppy disk, CD-ROM, DVD, magnetic disk, memory chip, ROM, RAM, EEPROM, EPROM, flash memory, optical media, or any other suitable memory from which processor 202 can read instructions. The instructions may include code from any suitable computer programming language such as, but not limited to, C, C++, C#, Java, JavaScript, Perl, HTML, XML, Python and Visual Basic.

Client device 200 may include one or more network interfaces 206. A network interface 206 may include any type and form of interface, including Ethernet including 10 Base T, 100 Base T, or 1000 Base T (“Gigabit”); any of the varieties of 802.11 wireless, such as 802.11a, 802.11b, 802.11g, 802.11n, or 802.11ac; cellular, including CDMA, LTE, 3G, or 4G cellular; Bluetooth or other short range wireless connections; or any combination of these or other interfaces for communicating with a network 106. In many implementations, client device 200 may include a plurality of network interfaces 206 of different types, allowing for connections to a variety of networks 106 or a network 106 such as the Internet via different sub-networks.

Client device 200 may include one or more user interface devices 208. A user interface device 208 may be any electronic device that conveys data to a user by generating sensory information (e.g., a visualization on a display, one or more sounds, tactile feedback, etc.) and/or converts received sensory information from a user into electronic signals (e.g., a keyboard, a mouse, a pointing device, a touch screen display, a microphone, etc.). The one or more user interface devices may be internal to the housing of client device 200, such as a built-in display, touch screen, microphone, etc., or external to the housing of client device 200, such as a monitor connected to client device 200, a speaker connected to client device 200, etc., according to various implementations.

Client device 200 may include in memory 204 an application 210 or may execute an application 210 with a processor 202. Application 210 may be an application, applet, script, service, daemon, routine, or other executable logic for receiving content and for transmitting responses, commands, or other data. In one implementation, application 210 may be a web browser, while in another implementation, application 210 may be a video game. Application 210 may include functionality for displaying content received via network interface 206 and/or generated locally by processor 202, and for transmitting interactions received via a user interface device 208, such as requests for websites, selections of survey response options, input text strings, etc.

In some implementations, application 210 may include a data collector 212. For example, data collector 212 may include an application plug-in, application extension, subroutine, browser toolbar, daemon, or other executable logic for collecting data processed by application 210. In other implementations, a data collector 212 may be a separate application, service, daemon, routine, or other executable logic separate from application 210 but configured for intercepting and/or collecting data processed by application 210, such as a screen scraper, packet interceptor, API hooking process, or other such application. Data collector 212 may be configured for intercepting or receiving data input via user interface device 208, such as Internet search queries, text strings, survey response selections, or other values, or data received and processed by application 210 including websites visited, time spent interacting with a website or application, pages read, or other such data. In many implementations, data collector 212 may store some or all of this data or identifiers of such data in a behavior history database 216. For example, behavior history database 216 may include identifications of websites visited, web links followed, search queries entered, or other such data. In some implementations, behavior history database 216 may be anonymized or disambiguated to reduce personally identifiable information. For example, rather than recording individual search queries entered, such as a query for “vacation spots in France”, a data collector 212 may identify predetermined categories corresponding to the search queries, such as “European tourism” or “travel” and record an indication of a search relating to the predetermined category in behavior history database 216. This may allow for increased privacy while still properly characterizing a survey respondent. In other implementations, the data collector 212 may be executed by a server, or by an intermediary device deployed between the client and server, such as a router, cable modem, or other such device. For example, data requests and responses may be parsed by a data collector 212 executing on an intermediary router as the requests and responses traverse the router. In some implementations, this may allow for monitoring of all data flow to/from a household, without requiring installation of the data collector 212 on a plurality of devices within the household.

Behavior history database 216 may be used to identify characteristics of the user of client 200. Such characteristics may include affinities, sometimes referred to as interest categories or traits, such as shopping or entertainment preferences or demographic information. History data may be any data associated with a device identifier 214 that is indicative of an online event (e.g., visiting a webpage, interacting with presented content, conducting a search, making a purchase, downloading content, etc.). For example, if a client 200 frequently transmits search queries identifying a particular sports team, the database 216 may be used to identify that the user has an affinity for the team, the particular sport, the region the team is based in, sports in general, or any other such affinities at varying levels of granularity. In some cases, affinities may conform to a taxonomy (e.g., an interest category may be classified as falling under a broader interest category). For example, the affinity of golf may be /Sports/Golf,/Sports/Individual Sports/Golf, or under any other hierarchical category. Affinities may be dynamically generated responsive to a search query or website visit, or may be predetermined categories, such as “basketball” or “politics”. In implementations with predetermined categories, behavioral history may be classified as belonging to a predetermined category. For example, a search for a particular basketball team may be classified as belonging to a predetermined “basketball” affinity. In one implementation, such classification may be performed by parsing the query, search results, or visited webpage for keywords related to the affinity.

More frequent searches, website visits, related products purchased, etc. may indicate a higher level of an affinity, while single searches or visits may indicate a low level of affinity. In some implementations, single searches or visits may be disregarded, to avoid false positives. Similarly, in some implementations, a top n-number of affinities having the highest weightings may be stored with lower value affinities disregarded. An affinity weighting may be based on, for example, the number of webpages visited by the device identifier regarding the affinity, when the visits occurred, how often the topic of the affinity was mentioned on a visited webpage, or any online actions performed by the device regarding the affinity. For example, topics of more recently visited webpages may receive a higher weighting than webpages that were visited further in the past. Affinities may also be subdivided by the time periods in which the webpage visits occurred. For example, the interest or product affinities may be subdivided into long-term, short-term, and current categories, based on when the device visited a webpage including content associated with the affinity. Thus, in some implementations, data collector 212 or another device may identify one or more affinities corresponding to behavioral actions and affinity values corresponding to a frequency or rate of such actions. A characteristic model may be generated based on the identified affinities and corresponding levels and associated with the device identifier 214. In some implementations, the model may be generated by client 200, such as by data collector 212. In other implementations, the model may be generated by an application on a server or other computing device. In such implementations, data collector 212 may transmit some or all of behavior history 216 to the server or other computing device. In many such implementations, data collector 212 may not perform any classification of affinities. In still other implementations, data collector 212 may perform classification of affinities, and transmit affinity indicators to a server or other computing device for building a model, such as via parameter-value pairs. Such parameters may be predetermined or dynamically generated, as discussed above.

Client 200 may include or be identified with a device identifier 214. Device identifier 214 may include any type and form of identification, including without limitation a MAC address, text and/or numerical data string, a username, a cryptographic public key, cookies, device serial numbers, user profile data, network addresses, or any other such identifier that may be used to distinguish the client 200 from other clients 200. In some implementations, a device identifier 214 may be associated with one or more other device identifiers 214 (e.g., a device identifier for a mobile device, a device identifier for a home computer, etc.).

Referring now to FIG. 2B, illustrated is a block diagram of an implementation of a computing device or server 218, such as a server 108 or content provider 110 discussed above in connection with FIG. 1. As with client devices 200, server 218 may include one or more processors 202, memories 204, network interfaces 206, and user interfaces 208. In some implementations referred to as headless servers, a server 218 may not include a user interface 208, but may communicate with clients 200 with user interfaces 208 via a network 106. Memory 204 may include content storage 232, such as storage of webpages, images, audio files, video files, data files, or any other type and form of data. In some implementations, memory 204 may store one or more applications 210 for execution by processor 202 of the server 218, including FTP servers, web servers, mail servers, file sharing servers, peer to peer servers, or other such applications for delivering content stored in content storage 232.

Server 218 may execute a survey selector 220. Survey selector 220 may be an application, service, server, daemon, routine, or other executable logic for selecting a survey from a survey database 226 and for transmitting the survey to a client 200 via network 106. In some implementations, transmission of the survey to a client may be via a separate application, such as a web server or data server. In some implementations and discussed in more detail below, the survey may be delivered as a pop-up window or other element on a website for the respondent to complete for access to premium content. Surveys may include one or more questions and, in some implementations, one or more predetermined answers for a respondent to select from. For example, a survey may ask how often a respondent watches movies, and predetermined answers may include daily, one to two times per week, one to two times per month, one to two times per quarter, one to times per year, less often, or never. In other implementations, the survey may ask the respondent for an input value, such as minutes of television watched per week, miles traveled to commute, or any other such value. Survey responses may accordingly comprise an identifier of a predetermined value, a data string, a numerical value, or any other such value. Survey responses may be received by a server 218 from a client 200 and stored in a survey database 226 and associated with a device identifier 214 received from the client 200, a behavioral history 216 received from the client 200, an affinity or characteristic model, an account profile, or any other such data.

Surveys may be selected responsive to a device identifier 214 received from client 200, responsive to affinities received from client 200, and/or responsive to a characteristic model generated as discussed above. For example, a survey identified as relating to basketball may be transmitted to a client 200 with an identified affinity for basketball based on past search queries or page visits. Surveys may also be selected responsive to having been transmitted to the client 200 previously, for follow-up surveying (for example, repeating the same question after three months to determine whether the response has changed), or responsive to not having been transmitted to the client 200 previously (for example, to avoid boring the user by repeatedly asking the same question). In one implementation, a survey may be selected to confirm a model or determined affinity, to verify that analysis algorithms are correct. For example, a survey explicitly asking whether the respondent likes basketball may be transmitted to a client 200 that has transmitted search queries relating to a basketball team. Surveys may also be selected to identify correlations between affinities, such as a survey asking whether the respondent likes basketball being transmitted to a client 200 that has transmitted search queries relating to baseball. Non-intuitive affinity correlations may be identified this way, such as potential correlations between interests in a particular sport and interests in foreign travel or investing. Although primarily discussed in terms of survey selection by a server, in some implementations, a survey selector or survey filter may be executed by a client device. For example, in one implementation, a survey may be sent to one or more clients 200 and each client 200 may determine, responsive to affinities identified in the behavioral history of said client, whether to display the survey to a user. In another implementation, a client 200 may request a specific survey or survey from a specified set of surveys (e.g. a set of surveys corresponding to an affinity), responsive to affinities identified in the behavioral history of the client. These implementations may increase privacy by not requiring transmission of behavioral history beyond the client. For example, a client 200 may identify that a number of queries related to baseball have been transmitted, from a locally stored behavioral history. The client 200 may then transmit a request for a survey related to sports, a survey related to baseball specifically, a survey related to a particular team, etc.

Server 218 may include an aggregated regional history database 228. Aggregated regional history database 228 may include an identification of search queries, page visits, or other actions generated by devices 100, 102 in a region 104. In some implementations, regional history database 228 may include an identification or log of all such actions, while in other implementations, regional history database 228 may aggregate the actions into action-value pairs, with values indicating the number of the corresponding actions taken by devices 100, 102. Such values may be total numbers, or may be percentages, proportional reporting ratios, weights, or other statistical values. As discussed above in connection with client behavior history database 216, actions from devices 100, 102 may be disambiguated into predetermined or dynamically generated affinities, such as “sports” or “investing”. Aggregation of such affinities based on actions from devices 100, 102 in a region 104 may thus provide an anonymized view of actions by the region generally, without personally identifiable information of users of such devices.

In one implementation, actions may be collected for inclusion in aggregated regional history database 228 by data collectors 212 executed by devices 100, 102. In other implementations, actions may be collected by a server, such as server 108 or a content provider 110 and identified as generated by a device 100, 102 in a region based on geolocation information such as internet protocol (IP) source addresses corresponding to a regional provider, device identifiers 214, time zone information, language, or any other such explicit or implicit information. For example, in one implementation, a content provider 108 may maintain local servers in various cities for geographic caching, with locally generated requests sent to local servers through optimum path-seeking routing protocols. Received requests may be implicitly identified as generated locally within the corresponding region. In some implementations, the history 228 may be periodically or dynamically refreshed, with actions beyond a specified age discarded. This may prevent short-term popular trends from adversely affecting the model over longer periods of time.

Aggregated regional history may be used to generate a model of the region 230, similar to generating a model corresponding to a device identifier 214 and based on a behavioral history 216. For example, a large number of search queries from devices in a particular region may be for the same or related information, such as a local sports team name, a player for the team, a stadium location, or other such data. These queries may be aggregated together and weighted based on the frequency and/or number of searches to identify an affinity and corresponding value. A model 230 may be generated from some or all of the affinities and values, such as the top n-number of affinities, the model representing the likely affinities of any individual entity within the region. Such models 230 based on aggregated actions may be highly accurate, as the sample size for search queries or page visits from devices 100, 102 in a region 104 may be upwards of 10% of the population of such devices, possibly even approaching 100%. While not every device within the region will necessarily match the model, users with similar interests or affinities tend to be clustered, and accordingly, the model 230 may be very accurate generally. In some implementations, both the aggregated regional history 228 and model 230 may be stored. In other implementations, the history 228 may be discarded and only the model 230 stored, increasing anonymity of the region 104. In other implementations, the history 228 may be stored, and the model 230 may be generated as needed.

Server 218 may execute a correlator 222. Correlator 222 may be an application, service, server, daemon, routine, or other executable logic for correlating affinities or characteristics of a model associated with a device identifier 214 with affinities or characteristics of a regional model determined from an aggregated regional history stored in a database 228. Correlator 222 may compare affinity-value pairs in each model, the order of affinities in a ranked list, or any other such information to determine whether and how closely the model associated with the device identifier 214 correlates with the model associated with a region 104. If the correlation is below a threshold, the correlator 222 may indicate that the client 200 associated with the device identifier 214 does not represent the region 104. If the correlation is above a threshold, the correlator 222 may indicate that the client 200 associated with the device identifier 214 does represent the region 104. In some implementations, the degree of statistical correlation or a correlation coefficient may be used to determine how much a client 200 represents or does not represent the region 104. Correlation coefficients may be calculated via one or more methods, including a Pearson product-moment correlation algorithm or any other type and form of algorithm for comparing multiple pairs of values.

Server 218 may execute a result probability calculator 224. Result probability calculator 224 may be an application, service, server, daemon, routine, or other executable logic for calculating the probability of a particular survey result for all members of a region 104, based on one or more correlations between models associated with device identifiers 214 and a regional model 230, and survey results from the clients 200 associated with the device identifiers 214. For example, if a model associated with a device identifier 214 is highly correlated with a regional model 230 and responds to a survey with a first value, then result probability calculator 224 may determine that members of the region 104, if queried, would likely respond to the survey with the same or a similar value. Conversely, if the model associated with the device identifier 214 is highly negatively correlated with the regional model 230, then result probability calculator 224 may determine that members of the region 104, if queried, would likely not respond to the survey with the same or a similar value. Survey results from multiple respondents may be aggregated to estimate the overall result probability for the region, weighted by correlation coefficients in some implementations or discarded if a correlation coefficient is below a predetermined threshold in other implementations. Accordingly, rather than simply using survey responses from a random sampling of individuals, who may in fact be statistical outliers and not representative of the region, to determine likely rates of responses from the regional population, the result probability calculator 224 may calculate likely rates of responses based on individuals who may be objectively determined to represent the population, based on similar interests.

In some implementations, surveys may be presented to clients periodically. For example, a user may agree to take a daily or weekly survey. The user may receive an incentive for participation, such as points, tokens, coupons, access to services, money, goods, badges, or other incentives. However, some such implementations may result in a narrowed selection of respondents who are willing to sign up for such agreements, and may thus not represent the population as well as possible. In another implementation, surveys may be presented to clients responsive to a request for premium content, such as a news media article, streamed television show, game play tokens, an advertising-free viewing period of content that normally includes advertising, or other such premium content. Clients may decline to answer the survey and may be presented with a non-premium version of the content, such as a truncated article or television with embedded advertising. Because many users who would not sign up to take surveys periodically may be willing to answer one in exchange for access to content, such implementations may reach a wider and more varied population of respondents.

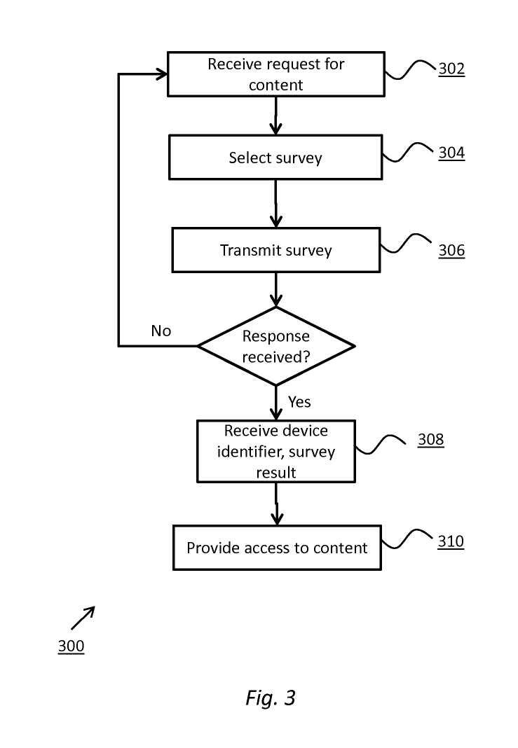

Referring now to FIG. 3, illustrated is a flow chart of a method 300 for providing access to content responsive to successful completion of a survey, according to a first implementation. In brief overview of method 300, at step 302, a server may receive a request for an item of content. At step 304, the server may select a survey, and at step 306, the server may transmit the survey to the client. If no response to the survey is received, in some implementations, the server may deny access to the item of content or provide an alternate item of content, to incentivize responding. Conversely, at step 308, the server may receive a survey response including a result or value for the survey and, in some implementations, a device identifier. Responsive to receiving the survey result, the server may provide access to the content at step 310.

Still referring to FIG. 3 and in more detail, at step 302, a server may receive a request for an item of content. As discussed above, items of content may include data, images, text, executable code, video, audio, or any other such content, including code in a hypertext markup language (HTML), extensible HTML (XHTML), extensible markup language (XML), JavaScript, or any other language. As discussed above, in some implementations, the server may be deployed as an intermediary between a client and a content provider or the server may include the content provider and may thus receive the request directly. In other implementations, the server may intercept the query in transit to a content provider. In some implementations, a client may receive a first item of content from a content provider, the first item of content including an executable script directing the client to request a second item of content from the server. For example, a client may retrieve a web page from a content provider, such as a news media site, the web page including a script directing the client web browser to transmit a request for a survey to the server for display by the client. Accordingly, in many implementations, the request may comprise an HTTP GET request or similar request for data. In some implementations, the server may receive a device identifier, such as a cookie or other identifier, as discussed above.

At step 304, the server may select a survey for transmission to the client. In some implementations, surveys may be selected responsive to a device identifier or a behavioral history of the client, such as recent search queries or pages visited. In some implementations, as discussed above, surveys may be selected responsive to estimated affinities in a model associated with the device identifier to explicitly confirm affinity estimates. In other implementations, surveys may be selected responsive to a region containing the client.

At step 306, the selected survey may be transmitted to the client. As discussed above, the survey may include images and/or text, and may include a plurality of predetermined result values, such as “yes”, “no”, “once per week”, “once per month”, “25-50”, or any other such values based on the survey question. In other implementations, the survey may allow the client to provide a data string or numerical value in response. In some implementations, the survey may be transmitted to the client as a web page or executable code for display in a pop-up window, embedded window, frame, portion of a web page, banner, interactive portion of a video or other presentation, or any other type and form of interactive element. For example, in one implementation, the survey may include code causing a client web browser to display a survey question and a plurality of buttons with labels corresponding to predetermined result values, with selection of a button by the user causing the client device to transmit a response to the server. In some implementations, the server may transmit a cookie or other identifier, such as a dynamically generated random number or pseudo-random number, to the client with the survey to be returned with the response for verification.

If no response is received (for example, if the user closes the webpage or browser, or clicks on a “refuse to answer” or close button on the survey), then in some implementations, the server may not provide access to premium content and/or may transmit or direct the client to retrieve non-premium content. Method 300 may repeat step 302 for the client or other clients.

Conversely, the server may receive a survey result at step 308. In some implementations, the server may receive a device identifier with the survey result, or may receive a cookie or other identifier transmitted to the client with the survey at step 306. In implementations in which the server receives an identifier transmitted to the client at step 306, the server may receive the device identifier at step 302, and may associate the identifier transmitted at step 306 with the device identifier. Accordingly, the server may associate the survey result with the client having the received device identifier, and may further associate the survey result with an affinity model generated according to behavioral history of the client. The survey result may be received as a parameter-value pair, a data string, a numerical value, or any other type and form of data. For example, in one implementation, a user may select a survey response displayed in a pop-up window, causing the client to transmit an HTTP GET query for a URL managed by a web server of the server, the URL including a parameter-value pair corresponding to the survey response value.

At step 310, responsive to receiving the survey result at step 308, the server may provide access to premium content. In some implementations, the server may redirect the client to a source for premium content, while in other implementations, the server may transmit a request to a content provider to provide premium content to the client. In still other implementations, the server may transmit an authorization code or token to the client for processing by an application of the client. For example, processing the authorization code may allow the client to display encrypted data of premium content, transmit other requests including the authorization code to content providers, enable a disabled feature of an application, or perform other such functions.

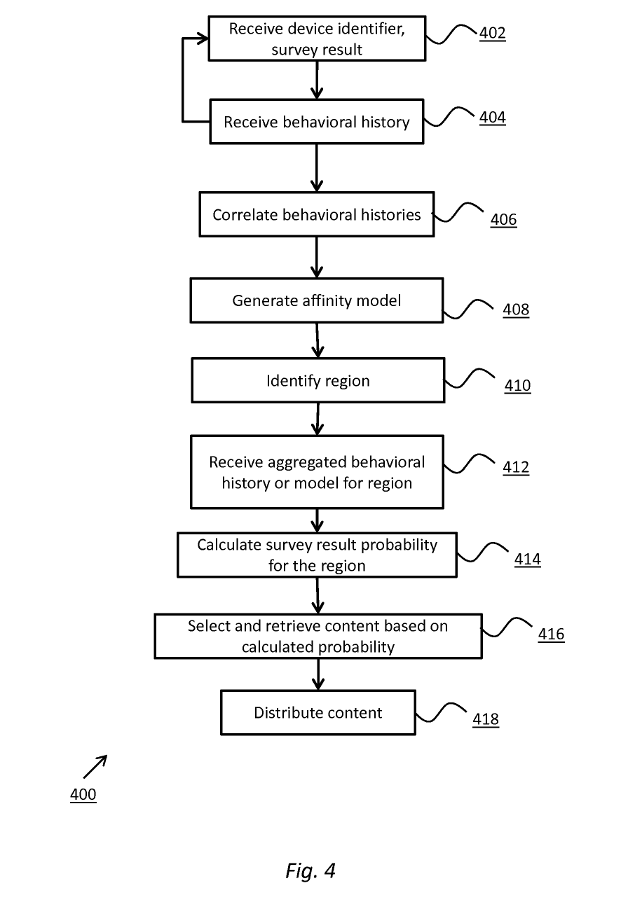

FIG. 4 is a flow diagram of a method 400 for improving targeted distribution of content via regional search histories, according to one implementation. In brief overview, at step 402, a server may receive a device identifier and a survey result, as discussed above in connection with FIG. 3. At step 404, the server may retrieve or receive a behavioral history associated with the device identifier. At step 406, in one implementation, the server may repeat steps 402-404 for a plurality of behavioral histories of survey respondents, and correlate the plurality of behavioral histories to generate an aggregated affinity model at step 408 based on the correlated histories. At step 410, the server may identify a region associated with the device identifier or identifiers. At step 412, the server may receive or retrieve an aggregated behavioral history for the region or an affinity model for the region generated from the aggregated behavioral history. At step 414, the server may calculate a survey result probability for the region, based on the aggregated behavioral history, the affinity model or models associated with the device identifier or identifiers, and the survey results. In other implementations, step 406 may be skipped and the server may perform one or more of steps 408-414 iteratively for a plurality of behavioral histories associated with device identifiers of survey respondents, generating an affinity model for each device identifier and adjusting a calculated survey result probability accordingly (in some such implementations, steps 410 and 412 may need to be performed only once). At step 416, responsive to the calculated survey result probability, the server may select and/or retrieve an item of content. At step 418, the server may distribute the item of content or cause a content provider to distribute the item of content to the region.

Still referring to FIG. 4 and in more detail, at step 402, a server may receive a device identifier and a survey result from a client. Although shown as a single step, as discussed above in connection with FIG. 3, the server may receive the device identifier and survey result separately. In many implementations, the server may receive the survey result responsive to providing the survey for access to premium content, as discussed above. Accordingly, in such implementations, the server may provide access to the content, as in step 310.

At step 404, in some implementations, the server may receive or retrieve a behavioral history associated with the device identifier. As discussed above, in some implementations, a data collector executed by the client may transmit behavioral history information to the server responsive to transmitting the survey result, periodically, or dynamically as actions are taken by the client. Accordingly, in some implementations, the server may receive the behavioral history from the client at step 404, while in other implementations, the server may retrieve the behavioral history from a behavioral database stored on the server or another computing device.

In one implementation as shown, steps 402 and/or 404 may be repeated for a plurality of survey respondents. For example, the server may wait until a large number of survey results are received before calculating a survey result probability for the region. In other implementations, the server may calculate a survey result probability immediately and may update the calculation as each new survey result is received. In some implementations in which a plurality of survey results are received, at step 406, the server may aggregate or correlate the behavioral histories associated with each device identifier or a subset of the behavioral histories to generate an aggregated affinity model for respondents of the survey. In many such implementations, the survey results may be filtered or a subset of the behavioral histories may be extracted responsive to the survey results. For example, behavioral histories associated with device identifiers with a corresponding survey result having a first value, such as “yes”, may be extracted and correlated to generate an affinity model for respondents answering “yes” to the survey. Similarly, behavioral histories associated with device identifiers with a corresponding survey result having a second value, such as “no”, may be extracted and correlated to generate an affinity model for respondents answering “no” to the survey. Accordingly, for each possible value or range of values of the survey, the server may extract a corresponding subset of behavioral histories of survey respondents and, at step 408, generate an aggregated affinity model associated with said value or range.

In one implementation of step 406, behavioral histories of survey respondents providing survey answers with the same value may be aggregated to generate a combined behavioral history. Affinities may be identified from the combined behavioral history at step 408 according to proportional reporting rates, frequencies, or other such statistical measures. In another implementation of step 406, correlations between the behavioral histories may be identified to generate a correlated behavioral history and affinity model identifying shared affinities at weights according to their correlation coefficient. In still another implementation, affinity models may be generated for each behavioral history, and the affinity models combined or correlated to create an affinity model corresponding to the survey result. Such implementations may be utilized in instances in which the server does not store behavioral history data, but merely affinity models for each device identifier.

In another implementation, step 406 may be skipped, and at step 408, the server may generate an affinity model for each survey respondent, based on the behavioral history associated with the corresponding device identifier. As discussed above, the affinity model may be generated dynamically as behavioral history information is received. Accordingly, in some implementations, steps 404 and 408 may occur before step 402, and instead, responsive to receiving the survey result and device identifier at step 402, the server may retrieve a previously generated affinity model associated with the received device identifier.

At step 410, the server may identify a region associated with the plurality of device identifiers. As discussed above, in some implementations, the region may be a geographical region including the devices associated with the device identifiers. The region may be identified responsive to geolocation information associated with the device identifiers. In other implementations, the region may be a virtual region associated with a characteristic.

At step 412, the server may receive or retrieve an aggregated behavioral history and/or affinity model for the region. As discussed above, the affinity model may be generated from the aggregated behavioral history of devices in the region. The model may be generated at step 412 after retrieving the aggregated behavioral history, or may be periodically or dynamically generated or updated as device actions are added to the aggregated behavioral history. For example, the server may update the affinity model each time it receives a search query from a device in the region.

At step 414, the server may calculate a survey result probability for the region corresponding with the value of the survey result or results received at step 402, or a subset of the matching result values, based on a correlation between the aggregated affinity model or individual affinity models of the survey respondents and the affinity model for the region. In some implementations, a correlation coefficient between the respondent affinity model or models and the region affinity model may be proportional to a weight applied to a response rate for a particular value. For example, if 50% of respondents respond “yes” to a particular survey question, but the respondents are positively correlated with the region with a coefficient of 0.9, then the server may increase a calculated probability of “yes” to the question for the region by a proportional amount, such as from 50% to 90%. Conversely, if the respondents are negatively correlated with the region with a coefficient of −0.9, the server may decrease a calculated probability of “yes” to the question by a proportional amount, such as from 50% to 10% (the particular values provided are by way of example only, and in practice may be larger or smaller). Such adjustments to a value for a survey response rate may be linear or non-linear, and may be biased to more heavily penalize negative affinity correlations or more heavily favor positive affinity correlations. In some implementations, adjustment weights may be configured for each survey question. For example, for some survey questions with particularly rare response rates, such as “are you getting married within the next three months,” negative responses may be much more common than positive responses. Accordingly, even if affinity models of positive responders are highly correlated with the region model, the calculated probability may be adjusted by a lesser amount. For example, if 1% respond “yes” to such a question, but correlate with the region with a coefficient of 0.9, the server may increase an estimated response probability for “yes” from 1% to 1.5%. Thus, adjustments may be based on the survey response rate as well as a correlation of affinities between models.

At step 416, the server may select and/or retrieve one or more items of content responsive to the calculated survey result probability for the region. Items of content may include, for example, advertising corresponding to the survey result. For example, if a large number of responders highly correlated with a region provide a survey result indicating they are likely to purchase a new smart phone within three months, the server may select and/or retrieve smart phone advertisements to distribute to the region, as many individuals in the region may be similar to the responders. Such items of content may be distributed at step 418 via one or more means, such as broadcast via television or radio to devices in the region, provided in banners or frames or embedded content on web sites visited by devices in the region, mailed in hard copy format to individuals in the region, placed on billboards in the region, or otherwise distributed. Accordingly, in many implementations, the items of content may be distributed to devices or individuals in the region based on aggregated characteristics of the region model and agnostic to individual traits, affinities, or characteristics of the individuals or devices. In many implementations, particularly where distribution of the content is not via a network connected to the server, the server may send a request to a separate content provider to distribute the item of content to the region.

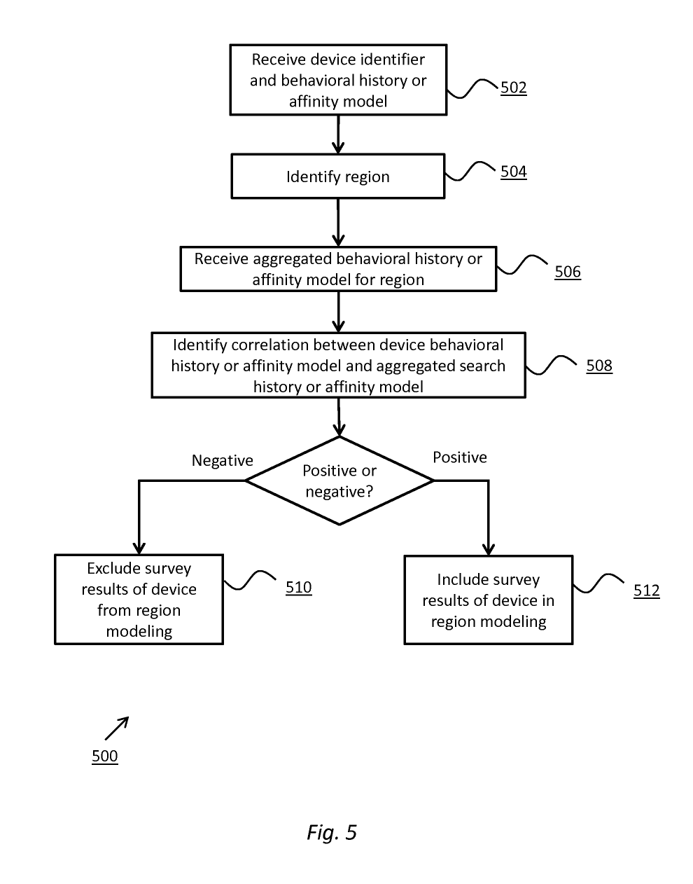

Referring to FIG. 5, illustrated is a flow diagram of the steps taken in one implementation of a method 500 for survey amplification. Method 500 is similar in many aspects to method 400, and provides for exclusion or removal of search results from negatively correlated respondents. In brief overview, at step 502, a server may receive a device identifier and behavioral history or affinity model associated with the device identifier. At step 504, the server may identify a region associated with the device identifier. At step 506, the server may receive or retrieve an aggregated search history for the region or an affinity model associated with the region. At step 508, the server may identify a correlation between the device behavioral history or affinity model, and the aggregated behavioral history or affinity model of the region. If the correlation is negative, then at step 510, the server may exclude survey results of the device from probability calculations for survey results for the region. If the correlation is positive, then at step 512, the server may include survey results of the device in probability calculations for survey results for the region.

Still referring to FIG. 5 and in more detail, in some implementations, the server may receive a device identifier at step 502. The server may also receive a survey result, as at step 402 of FIG. 4, and may also receive or retrieve a corresponding behavioral history and/or affinity model associated with the device identifier, as discussed above at step 404 of FIG. 4.

At step 504, the server may identify a region including the device. As discussed above, the region may be a geographic region or a virtual region or set. At step 506, the server may retrieve an aggregated behavioral history for the identified region, and/or may retrieve an affinity model for the region generated from the aggregated behavioral history. As discussed above, the affinity model for the region may be generated periodically, dynamically, or as needed.

At step 508, the server may correlate the affinity model associated with the device identifier and the affinity model of the region, or correlate the behavioral history of the device and the aggregated behavioral history of the region. Correlation of the models or histories may comprise comparison of pairs of corresponding affinity values, behavioral actions or search query classifications and frequencies, or other such data.

If the behavioral history or affinity model associated with the device identifier is negatively correlated or not correlated with the behavioral history or affinity model of the region, then at step 510, survey results associated with the device identifier may be excluded from calculations of survey result probabilities for the region. In one implementation, the server may determine whether an affinity value associated with the device identifier is within a predetermined range of an affinity value associated with the region. For example, an affinity associated with the device identifier of “basketball” having a value of 0.6 may be compared to a corresponding affinity of the region of “basketball” having a value of 0.85. If the predetermined range is 0.2, for example, such that the difference between the values is greater than the range, the model associated with the device identifier may be considered negatively correlated with the regional model. Similar comparisons may be made for a plurality of affinities and values. In some implementations, survey results may be excluded by including the results, weighted down by a large weight, while in other implementations, the results may be completely excluded. In one implementation, the device identifier may be added to an exclude list. In some implementations, other information associated with the device identifier may be excluded from modeling of the region. For example, behavioral history associated with the device identifier may be excluded from aggregation with behavioral history of other devices in the region for generation of the regional affinity model. This may allow for a more accurate model generation of the region by excluding outliers.

If the behavioral history or affinity model associated with the device identifier is positively correlated with the behavioral history of affinity model of the region, then at step 512, survey results associated with the device identifier may be used for survey result probability calculations, as discussed above in connection with FIG. 4. Similarly, other data associated with the device identifier may be included in region modeling, such as aggregated behavioral history data. In some implementations, the device identifier may be added to an include list.

By estimating survey result probability based on correlations between respondent characteristics and aggregated regional characteristics, a smaller sample size of respondents may be used while maintaining or even increasing accuracy and confidence of results. The resulting survey result probability may be used for targeting of advertising to the region, without invading privacy of individuals in the region that do not participate in surveys, as well as targeting advertising via non-interactive means, such as television, radio, billboards, or direct mail. Similarly, survey results may be used for other purposes, such as accurate regional political polling, by excluding or reducing influence of outlier respondents that do not truly represent likely voters. In other implementations, survey results may be used for market testing of proposed television programs, new store locations, or any other such uses, by amplifying response rate estimates responsive to affinity correlations. For example, shopping habits or store preferences for a few individuals within a region may be surveyed, and by verifying that the individuals properly represent the region, a market researcher can identify potential locations underserved by a store.

Similarly, although discussed primarily in terms of survey results, the methods and systems discussed herein may be used with other indicators of interest. For example, while a survey result may provide an explicit indicator of an interest of an individual, the interest may be determined implicitly for the individual based on search queries, purchase histories, device activations, or any other such indicators. Thus, in one such implementation, activation of a smart phone or particular model of tablet may be used in place of a survey regarding whether the user is likely to purchase the smart phone or tablet or whether the user prefers that model to other models. Characteristics or behavioral history associated with the individual may then be correlated with aggregated behavioral data or characteristics for a region to indicate how likely the region is to be interested in the particular model of smart phone or tablet. Accordingly, purchase or activation histories may be amplified in a method similar to survey amplification. In some implementations, these purchase or activation histories, search queries, or other such indicators of interest for an individual may be referred to generally as implicit indicators of interest, implicit survey results, or any other such similar terms.

In a similar implementation, response to content may be used as an implicit indicator of interest of an individual. For example, a selection or click-through of an advertisement displayed to the individual may be used to identify preference for the subject matter of the advertisement, or even features of the advertisement. In an example of the latter, advertisements may be displayed to various individuals with slightly different content or the inclusion or exclusion of phrases, such as “assembled in America” for a corresponding product; or various versions of content may be displayed for selection by the individual, such as an automobile commercial for a sporty coupe as one version and a commercial for a low environmental impact hybrid as another. Selection of a version of content may be used as an implicit indicator of interest or preference, which may then be amplified to a region as discussed above. In implementations with inclusion or exclusion of different phrases, for example, this process may indicate that individuals in a region are more or less likely to be persuaded by or prefer content including the phrase.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible.

The operations described in this specification can be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The features disclosed herein may be implemented on a smart television module (or connected television module, hybrid television module, etc.), which may include a processing circuit configured to integrate Internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

What is claimed is:

1. A method for improving targeted distribution of content via regional behavioral histories, comprising:
receiving, by a device, a plurality of device identifiers, and for each of the plurality of device identifiers, a corresponding survey result and a corresponding behavioral history associated with said device identifier;
identifying, by the device, a value of at least one affinity associated with a given survey result, based on a correlation of behavioral histories associated with device identifiers corresponding to the given survey result;
identifying, by the device, a region associated with the plurality of device identifiers;
retrieving, by the device, an aggregated behavioral history for the determined region;
calculating, by the device, a survey result probability for the determined region, based on the aggregated behavioral history and the identified value of the at least one affinity;
retrieving, by the device, at least one item of content associated with the survey result, the at least one item of content selected based on the survey result probability; and
distributing, by the device, the at least one item of content to a plurality of devices located in the determined region.

2. The method of claim 1, wherein identifying the value of at least one affinity associated with a given survey result further comprises:
extracting, from the plurality of behavioral histories associated with the plurality of device identifiers, a subset of behavioral histories associated with a device identifier with a corresponding survey result matching the given survey result.

3. The method of claim 2, further comprising identifying, from the subset of behavioral histories, a rate of appearance of one or more predetermined keywords corresponding to an affinity.

4. The method of claim 3, further comprising searching each behavioral history of the subset of behavioral histories for the one or more predetermined keywords corresponding to the affinity.

5. The method of claim 1, wherein identifying a region associated with the plurality of device identifiers further comprises receiving, for each of the plurality of device identifiers, a location identifier.

6. The method of claim 5, further comprising identifying a geographic region corresponding to the plurality of location identifiers.

7. The method of claim 1, wherein retrieving an aggregated behavioral history for the determined region further comprises retrieving an aggregated list of search queries of a second plurality of devices located in the determined region.

8. The method of claim 1, wherein calculating a survey result probability for the determined region comprises identifying, from the aggregated behavioral history for the determined region, a second value of the affinity within a predetermined range from the identified value of the affinity.

9. The method of claim 1, wherein distributing the at least one item of content to the plurality of devices located in the determined region further comprises distributing the at least one item of content via a broadcast medium.

10. The method of claim 1, wherein distributing the at least one item of content to the plurality of devices located in the determined region further comprises distributing the at least one item of content agnostic to device identifiers of the plurality of devices.

11. A system for improving targeted distribution of content via regional behavioral histories, comprising:
a device, comprising a processor and a memory, the processor configured for:
receiving a plurality of device identifiers, and for each of the plurality of device identifiers, a corresponding survey result and a corresponding behavioral history associated with said device identifier,
identifying a value of at least one affinity associated with a given survey result, based on a correlation of behavioral histories associated with device identifiers corresponding to the given survey result,
identifying a region associated with the plurality of device identifiers, retrieving an aggregated behavioral history for the determined region,
calculating a survey result probability for the determined region, based on the aggregated behavioral history and the identified value of the at least one affinity,
retrieving at least one item of content associated with the survey result, the at least one item of content selected based on the survey result probability, and
distributing the at least one item of content to a plurality of devices located in the determined region.

12. The system of claim 11, wherein the processor is further configured for extracting, from the plurality of behavioral histories associated with the plurality of device identifiers, a subset of behavioral histories associated with a device identifier with a corresponding survey result matching the given survey result.

13. The system of claim 12, wherein the processor is further configured for identifying, from the subset of behavioral histories, a rate of appearance of one or more predetermined keywords corresponding to an affinity.

14. The system of claim 13, wherein the processor is further configured for searching each behavioral history of the subset of behavioral histories for the one or more predetermined keywords corresponding to the affinity.

15. The system of claim 11, wherein the processor is further configured for: receiving, for each of the plurality of device identifiers, a location identifier; and for identifying a geographic region corresponding to the plurality of location identifiers.

16. The system of claim 11, wherein the processor is further configured for retrieving an aggregated list of search queries of a second plurality of devices located in the determined region.

17. The system of claim 11, wherein the processor is further configured for identifying, from the aggregated behavioral history for the determined region, a second value of the affinity within a predetermined range from the identified value of the affinity.

18. The system of claim 11, wherein the processor is further configured for distributing the at least one item of content via a broadcast medium.

19. The system of claim 11, wherein the processor is further configured for distributing the at least one item of content agnostic to device identifiers of the plurality of devices.

20. A computer-readable storage medium storing instructions that when executed by one or more data processors, cause the one or more data processors to perform operations comprising:
receiving a plurality of device identifiers, and for each of the plurality of device identifiers, a corresponding survey result and a corresponding behavioral history associated with said device identifier,
identifying a value of at least one affinity associated with a given survey result, based on a correlation of behavioral histories associated with device identifiers corresponding to the given survey result,
identifying a region associated with the plurality of device identifiers,
retrieving an aggregated behavioral history for the determined region,
calculating a survey result probability for the determined region, based on the aggregated behavioral history and the identified value of the at least one affinity,
retrieving at least one item of content associated with the survey result, the at least one item of content selected based on the survey result probability, and
distributing the at least one item of content to a plurality of devices located in the determined region.
